(19) United States
(12) Patent Application Publication
(10) Pub. No.: US 2007/0093927 A1
(43) Pub. Date: Apr. 26, 2007

(54) TRAVERSE MODULE TESTING SYSTEM AND METHOD

(76) Inventor: Cheng-Min Tsai, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,781

(22) Filed: May 3, 2006

(30) Foreign Application Priority Data
Oct. 21, 2005 (CN) 200510100573.2

(51) Int. Cl. G06F 7/66

(52) U.S. Cl. 700/129

(57) ABSTRACT

A traverse module testing system includes a display unit for displaying, an input/output port, a communicating module, and an interface module. The input/output port connects to a control platform. The control platform connects to a traverse module and at least one measuring tool. The communicating module is used for enabling the input/output port to receive measured data from the measuring tool via the control platform. The interface module is used for activating the measured data to be displayed on the display unit.

### FIELD OF THE INVENTION

This invention relates to testing systems and methods and, more particularly, to a testing system and a testing method for testing traverse modules of information recording and/or reproducing apparatus.

### DESCRIPTION OF THE RELATED ART

A general information recording and/or reproducing apparatus includes a traverse module for reproducing information from and/or recording information onto media. The traverse module is one of major factors that influence performance of the information recording and/or reproducing apparatus. The traverse module includes a pick-up unit, a pair of guiding rods, a driving motor for generating driving energy, and an energy transmission mechanism for transmitting the driving energy to the pick-up unit to drive the pick-up unit to move along the guiding rods. Before the information recording and/or reproducing apparatus is brought into market, tests should be performed to ensure that the traverse module satisfies specific requirements. Various measuring tools are employed for these tests, such as collimators for measuring horizontal angles of surfaces of the traverse modules, jitter meters for measuring jitter values of the pick-up unit, and/or various instruments for measuring static or dynamic friction coefficients of the energy transmission mechanism. Usually, each measuring tool performs an independent test task. An operator reads measured results from each measuring tool and records all measured results from the measuring tools. Tests performed this manner are inefficient and difficult to analyze errors that occur during the tests. In addition, the measured results are recorded manually and prone to unexpected human errors undetected in the measured results.

Therefore, a testing system that can tests the traverse module in a more efficient way is desired.

### SUMMARY OF INVENTION

A traverse module testing system includes a display unit for displaying, an input/output port, a communicating module, and an interface module. The input/output port connects to a control platform. The control platform is connected to a traverse module and at least one measuring tool. The communicating module is used for enabling the input/output port to receive measured data from the at least one measuring tool via the control platform. The interface module is used for activating the measured data to be displayed on the display unit.

A traverse module testing method includes steps of: receiving input commands from an input unit; transmitting measuring commands corresponding to the input commands to a control platform which is connected to at lease one measuring tool; receiving measured data from the measuring tool via the control platform; and displaying the measured data on a display unit. The measuring commands instruct the at least one measuring tool to measure a traverse module.

A storage medium is provided for recording an application program. The application program has a computer executable the steps of: receiving input commands from an input unit; transmitting measuring commands corresponding to the input commands to a control platform connecting to at lease one measuring tool; receiving measured data from the measuring tool via the control platform; displaying the measured data on a display unit. The measuring commands instruct the measuring tool to measure a traverse module.

Other advantages and novel features will become more apparent from the following detailed description of preferred embodiment when taken in conjunction with the accompanying drawings, in which:

### BRIEF DESCRIPTION OF DRAWINGS

FIG. 1 is a block diagram of a traverse module testing system in accordance with an exemplary embodiment, the traverse module testing system including a controlling unit;

FIG. 2 is a detailed block diagram of the controlling unit of FIG. 1; and

FIG. 3 is a flow chart illustrating a measuring procedure of the traverse module testing system of FIG. 1.

### DETAILED DESCRIPTION

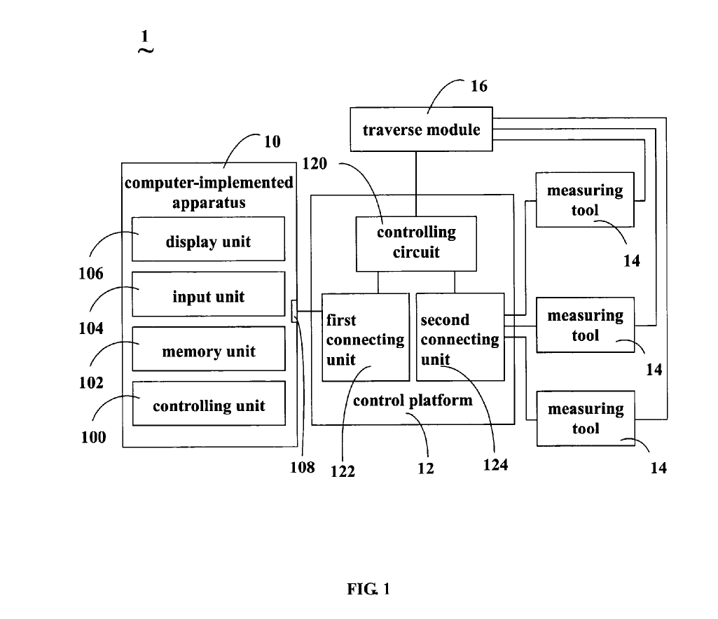

Referring to FIG. 1, a block diagram of a traverse module testing system 1 in accordance with a preferred embodiment is illustrated. The traverse module testing system 1 is used for testing a traverse module 16, and includes a computer-implemented apparatus 10, a control platform 12, and a plurality of measuring tools 14. The measuring tools 14 are used for measuring the traverse module 16, and can be collimators for measuring horizontal angles of surfaces of the traverse modules, jitter meters for measuring jitter values of the traverse modules, or various instruments for measuring static and/or dynamic friction of the traverse modules. The control platform 12 is connected to the traverse module 16 to control operations of the traverse module 16. For example, the control platform 12 can control the traverse module 16 to rotate or to be raised up or down. The control platform 12 is connected to the measuring tools 14 to receive measured data from the measuring tools 14, and is connected to the computer-implemented apparatus 10 to transmit the measured data to the computer-implemented apparatus 10.

The control platform 12 includes a controlling circuit 120 for controlling the operations of the traverse module 16, a first connecting unit 122 for connecting the control platform 12 to the computer-implemented apparatus 10, and a second connecting unit 124 for connecting the control platform 12 to the measuring tools 14. The second connecting unit 124 can be RS232 (recommend standard 232) ports. The first connecting unit 122 can be either an RS232 port or an RS232-to-USB (universal serial bus) converting device.

The computer-implemented apparatus 10 includes a controlling unit 100, a memory unit 102, an input unit 104, a display unit 106, and an input/output port 108. The controlling unit 100 is used for controlling data transfers between the computer-implemented apparatus 10 and the control platform 12, and for processing the measured data received from the measuring tools 14 to generate test reports. The memory unit 102 is used for storing the measured data. The input unit 104 is used for entering input commands. The display unit 106 is used for displaying the test reports. The input/output port 108 connects to the first connecting unit 122 of the control platform 12. When the first connecting unit 122 of the control platform 12 is the RS232 port, the input/output port 108 is the RS232 port. When the first connecting unit 122 of the control platform 12 is the RS232-to-USB converting device, the input/output port 108 is a USB port.

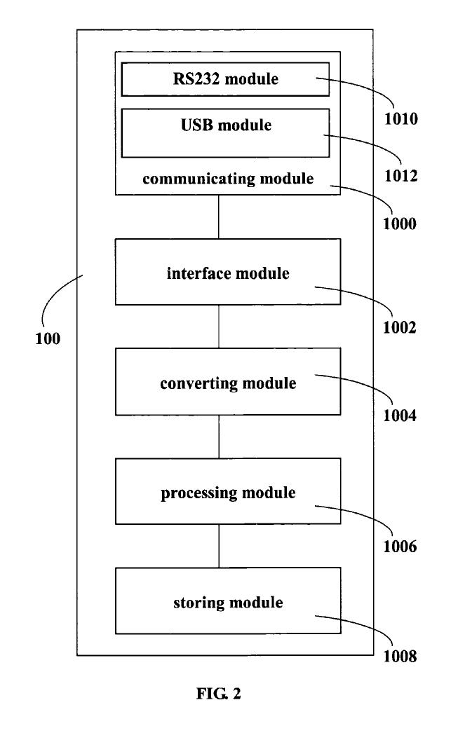

Referring to FIG. 2, a detailed block diagram of the controlling unit 100 is illustrated. The controlling unit 100 includes a communicating module 1000, an interface module 1002, a converting module 1004, a processing module 1006, and a storing module 1008.

The communicating module 1000 is used for controlling data transfers between the computer-implemented apparatus 10 and the control platform 12. The communicating module 1000 includes an RS232 module 1010 and a USB converting module 1012. The RS232 module 1010 is used for driving the RS232 port of the computer-implemented apparatus 10 to receive information from and send information to the first connecting unit 122 of the control platform 12. The USB module 1012 is used for driving a USB port of the computer-implemented apparatus 10 to receive the information from and send information to the first connecting unit 122 of the control platform 12.

The interface module 1002 is used for receiving the input commands from the input unit 104 and activating the test reports to be displayed on the display unit 106.

The converting module 1004 is used for formatting the measured data received from the measuring tools 14 into in a predetermined format. For example, if the measured data received from the measuring tools 14 are in machine codes, the converting module 1004 reformats the machine codes into plain texts. The measured data may include names of parameters and/or measured values of the parameters. The parameters may be surface evenness of the traverse module 16, friction coefficients, and/or variation coefficients.

The processing module 1006 is used for comparing the measured values with predetermined reference values to determine whether the traverse module 16 satisfies predetermined requirements, and for generating the test reports in given formats. The test reports may include the names of the parameters, the measured values of the parameters, reference values of the parameters, and comparisons between the measured values and the reference values. The storing module 1008 is used for recording the measured data and the test reports in the memory unit 102.

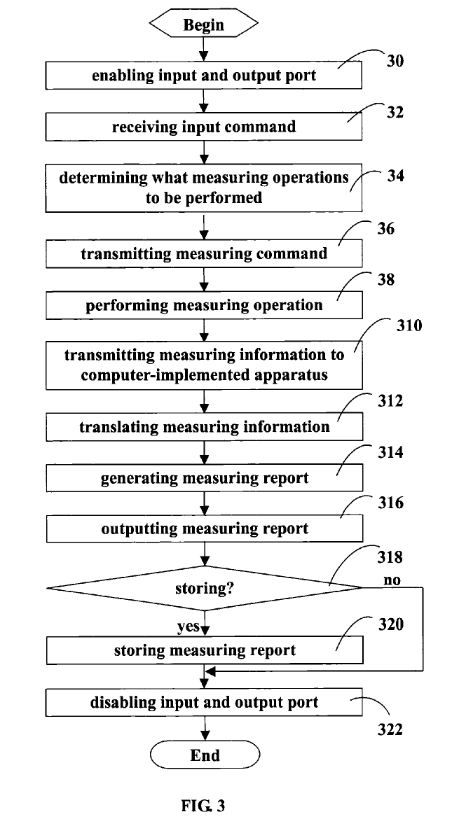

Referring to FIG. 3, a flow chart illustrating a testing procedure of the traverse module testing system 1 in accordance with an exemplary embodiment is illustrated. Firstly, in step 30, the communicating module 1000 enables the input/output port 108 to transfer data with the first connecting unit 122 of the control platform 12. Secondly, in step 32, the interface module 1002 receives input commands from the input unit 104. Then in step 34, the interface module 1002 determines what measuring operations are to be performed in an event-oriented manner based on the input commands. Based on the conclusion in step 34, in step 36, the interface module 1002 creates measuring commands corresponding to the measuring operations to be transmitted to the measuring tools 14.

In response to the measuring commands, the controlling circuit 120 of the control platform 12 controls the traverse module 16 to rotate or move, and the measuring tools 14 perform the measuring operations (in step 38). Then in step 310, the measured data are transmitted from the measuring tools 14 to the computer-implemented apparatus 10 via the control platform 12. Upon receiving the measured data, the converting module 1004 formats the measured data into the predetermined format (in step 312). Then in step 314, the processing module 1006 compares the measured values with the predetermined reference values to determine whether the traverse module 16 satisfies predetermined requirements.

Based on the measured values and the comparisons between the measured values and the predetermined reference values, the processing module 1006 generates the test reports in given formats. In step 316, the test reports are outputted to the interface module 1002 and displayed by the display unit 106. Then in step 318, a conclusion is made as to whether the test reports are to be stored. If the test reports are concluded to be stored, the storing module 1008 records the test reports to the memory unit 102 (in step 320). Finally, in step 522, the communicating module 1000 disables the input/output port 108. After step 522, the procedure is ended.

It should be noted that there may be more than one instance of the input/output port 108. In such a case, each input/output port 108 connects to a corresponding control platform 12. Thus, more than one traverse module 16 can be tested at the same time.

The embodiments described herein are merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims that follow, and their equivalents.

What is claimed is:

1. A traverse module testing system, comprising:
a display unit for displaying;
an input/output port being connected to a control platform, the control platform being connected to a traverse module and at least one measuring tool;
a communicating module for enabling the input/output port to receive measured data from the at least one measuring tool via the control platform; and
an interface module for activating the measured data to be displayed on the display unit.

2. The traverse module testing system as claimed in claim 1, further comprising a memory unit for recording the measured data.

3. The traverse module testing system as claimed in claim 1, further comprising a processing module for comparing the measured data with predetermined reference values to determine whether the traverse module satisfies predetermined requirements, and for generating test reports based on the measured data.

4. The traverse module testing system as claimed in claim 3, further comprising a converting module for formatting the measured data into a predetermined format.

5. The traverse module testing system as claimed in claim 1, wherein the input/output port is a recommend standard 232 port.

6. The traverse module testing system as claimed in claim 1, wherein the input/output port is a universal serial bus port.

7. A traverse module testing method comprising:
receiving input commands from an input unit;
transmitting measuring commands corresponding to the input commands to a control platform which is connected to at lease one measuring tool, the measuring commands instructing the at least one measuring tool to measure a traverse module;
receiving measured data from the measuring tool via the control platform; and
displaying the measured data on a display unit.

8. The traverse module testing method as claimed in claim 7, further comprising
formatting the measured data into a predetermined format, the measured data including measured values of parameters.

9. The traverse module testing method as claimed in claim 7, further comprising a step of comparing the measured values with predetermined reference values to determine whether the traverse module satisfies predetermined requirements.

10. The traverse module testing method as claimed in claim 7, further comprising a step of recording the measured data in a memory unit.

11. The traverse module testing method as claimed in claim 7, wherein the control platform is connected to a traverse module to control operations of the traverse module.

12. A storage medium recorded with an application program, the application program having a computer executable steps of:
receiving input commands from an input unit;
transmitting measuring commands corresponding to the input commands to a control platform connecting to at lease one measuring tool, the measuring commands instructing the measuring tool to measure a traverse module;
receiving measured data from the measuring tool via the control platform; and
displaying the measured data on a display unit.

13. The storage medium as claimed in claim 12, the application program having a computer executable step of determining what measuring operations to perform based on the input commands in an event-oriented manner.

14. The storage medium as claimed in claim 12, wherein the application program having a computer executable step of formatting the measured data into a predetermined format, the measured data including measured values of parameters.

15. The storage medium as claimed in claim 14, wherein the application program having a computer executable step of comparing the measured values with predetermined reference values to determine whether the traverse module satisfies predetermined requirements.

16. The storage medium as claimed in claim 12, wherein the application program having a computer executable step of recording the measured data in a memory unit.
